(19) United States
(12) Patent Application Publication
(10) Pub. No.: US 2011/0272038 A1
(43) Pub. Date: Nov. 10, 2011

(54) Adapter incorporating TPMS onto a truck valve

(76) Inventor: William C. Falkenborg, Tujunga, CA (US)

(21) Appl. No.: 12/799,965

(22) Filed: May 6, 2010

(51) Int. Cl. F16K 15/20

(52) U.S. Cl. 137/224; 137/223

(57) ABSTRACT

An adapter assembly is taught for attaching a tire pressure monitor onto an inflation valve which incorporates a distal end flange. An adapter is included in the assembly consisting of a collar having a configuration sized to fit over and be internally retained by the valve distal end flange, and an O-ring is positioned on the flange contiguously engaging the collar. A tire pressure monitoring cap is threadably attached to the collar which is disposed above and compresses the O-ring between the cap, collar and valve end flange. The adapter permits the tire pressure monitor to be attached, for use with a tire pressure monitoring system (TPMS) and also could prevent possible minor air leaks. The adapter may be packaged in a kit with appropriate instructions. Alternatively the tire inflation valve could be included with the adapter, forming the adapter assembly, or the monitor could be included in either case, when desired.

### TECHNICAL FIELD

The present invention relates to adapters in general. Specifically, for an adapter that permits the attachment of a tire pressure monitor in a “Tire Pressure Monitoring System” (TPMS) used with a conventional aluminum or steel wheel truck tire inflation valve.

### BACKGROUND ART

Previously, many types of tubeless tire inflation valves have been used in endeavoring to provide an effective means to attach to a wheel rim and integrally mount a sensor for a TPMS.

The prior art listed below did not disclose patents that possess any of the novelty of the instant invention; however the following U.S. patents are considered related:

| Pat. No. | Inventor | Issue Date |
|---|---|---|
| 4,117,281 | Leimbach | Sep. 26, 1978 |
| 4,819,685 | Pagani | Apr. 11, 1989 |
| 5,774,048 | Achterholt | Jun. 30, 1998 |
| 5,987,980 | Mangafas et al. | Nov. 23, 1999 |
| 6,005,480 | Banzhof et al. | Dec. 21, 1999 |
| US 6,799,455 B1 | Neefeldt et al. | Oct. 5, 2004 |
| US 7,624,752 B2 | Huang | Dec. 1, 2009 |

Leimbach in U.S. Pat. No. 4,117,281 teaches a device for filling a tire which will activate a warning device when internal pressure falls below a predetermined value. The device has a valve stem, a core and a diaphragm actuated electrical switch which signals when pressure is below the value.

Achterholt in U.S. Pat. No. 5,774,048 discloses a valve which generates a signal representing a pressure drop in a vehicle tire. A pressure sensor and microprocessor is provided which stores a value of the pressure in a memory and compares pressure, sending a signal periodically.

Mangafas et al. in U.S. Pat. No. 5,987,980 teach a tire valve having a pressure sensor and transponder. The sensing device is removable from the valve stem. The arrangement is electrically connected to the conductive portion of the valve element via the receptacle to facilitate an antenna system for radio frequency communication with the arrangement.

U.S. Pat. No. 6,005,480 issued to Banzhof et al. is for a tire pressure radio-frequency sending unit mounted to a snap-in resilient valve body with a column extending from the sending unit. The column defines a central passageway to facilitate insertion using standard insertion tools. In one version, two batteries are included in the sending unit disposed on opposite sides of the column.

Neefeldt et al. in U.S. Pat. No. 6,799,455 B1 discloses a tire pressure monitor continuously indicating it is adequately inflated for safe operation. The monitor includes an indicator associated with each tire indicating which tire is safe. The monitor includes a battery operated pressure sensitive radio frequency transmitter mounted on the outer end of a conventional tire valve stem and includes an antenna extending into each tire for transmitting a signal. The signal transmitted for the transmitter on each tire valve actuates only the indicator associated with a signal from only the transmitter assigned to each tire.

U.S. Pat. No. 7,624,752 B2 issued to Huang is for an inflation valve with two chambers and a central pin assembly mounted in an air inlet connector. When inflating a tire excessively the valve automatically releases surplus air via at least one pod in a second chamber by pushing a first valve body and a second valve body upward.

For background purposes and as indicative of the art to which the invention is related reference may be made to the remaining cited patent issued to Pagani in U.S. Pat. No. 4,819,685.

### DISCLOSURE OF THE INVENTION

Tire Pressure Monitoring Systems (TPMS) have been in use in automotive and truck applications for some time with automobile applications typically utilizing resilient snap-in tire valves with the valve body surrounded in part with a resilient element that forms an annular sealing surface around an opening in the wheel rim.

Truck and industrial off-road applications are somewhat different in that dual wheels, and the like, require longer valve stems typically made of metal, also hand bendable or flexible extensions are used. While many trucks include (TPMS) as original equipment there is always replacements required which could use a myriad of different monitors according to the requirement of the vehicles electronic control module.

The problem that has existed for some time is that dealers are required to stock each type of inflation valve with a varied combination of monitors along with valves without a monitor. It is therefore a primary object of the invention to provide a simple inexpensive adapter that converts a conventional valve into the type that incorporates the proper interface for attachment of the exact monitor. The use of this novel adapter answers the long felt need alleviating the burden of stocking considerable numbers of individual merchandise resulting in increased the stock turns of the common varieties.

An important object of the invention is there basically four types of interface configurations that are in common usage, an integral round hollow stem flattened on opposed sides having a lateral air egress hole therethough and screw threads within the hollow of the stem on a distal end for mounting a monitor with a threaded fastener. The second type is the same as above except less the flats. A third type incorporates a hollow radial dome with threads in the hollow for adjustable attachment and includes wrench flats on opposed sides while the fourth type is the same as above less wrench flats. Some less popular types also exist. At any rate the stocking distributor only needs to stock the most popular adapters and valves to meet the needs of the majority.

There are many different types of tire inflation valves for mounting in truck and specialized vehicle tires. The basic concept of the invention is adaptable to most inflation valve types as long as they have a distal end flange that is mounted inside the truck wheel, which are therefore included within the scope of this invention. The claims are specifically for industry standard Series 500, 540 and 550 inflation valves using an appropriate grommet which is either the commercially available style or an aftermarket type. The aftermarket type includes the OEM basic design with improvements enhancing the sealing ability of the inflation valve itself.

Another object of the invention is that the only requirement needed for a tire inflation valve is that it requires a distal end flange which is by far the majority of valves available on the market today. No other elements are required as the adapter collar simply slides over the stem and engages the inside surface of the flange, an O-ring is placed over the outside surface of the flange within the collar and a tire pressure monitoring cap is threaded into the collar. As the cap incorporates the proper interface mounting attachment for the monitor is easily attached using the threaded fastener hardware included with each monitor.

Still another object of the invention is that the invention utilizes an O-ring which creates a secondary sealing function in the event the grommet on the valve allows a leak path from ambient to the pressurized area of the tire.

Yet another object of the invention is in the fact that the flange on the valve may have a number of different outside shapes and still function properly such as hexagonal, polygonal etc. as well as the preferred conventional round configuration.

A further object of the invention is that the adapter may be employed with not only new valves but existing valves may be easily reused, of course with use of the usual recommended service packs.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a partial isometric view of the valve with the adapter assembly in the preferred embodiment, with the tire pressure monitor shown in dashed lines as it is not part of the invention.

FIG. 2 is a top elevation view of the valve with the adapter assembly in the preferred embodiment, with the tire pressure monitor shown in dashed lines as it is not part of the invention.

FIG. 3 is a partial cross sectional view taken along lines 3-3 of FIG. 2.

FIG. 4 is an exploded partial isometric view of the valve and the adapter assembly in the preferred embodiment.

FIG. 5 is an exploded partial isometric view of the adapter collar, O-ring and monitoring cap.

FIG. 6 is a cross sectional view taken along lines 6-6 of FIG. 7.

FIG. 7 is a front view of the adapter collar in the preferred embodiment.

FIG. 8 is a plan view of the O-ring.

FIG. 9 is a cross sectional view taken along lines 9-9 of FIG. 10.

FIG. 10 is a left side view of tire pressure monitoring cap with an integral protruding round hollow stem with flats in the preferred embodiment.

FIG. 11 is a top elevation view of the tire pressure monitoring cap in the preferred embodiment

FIG. 12 is a front view of tire pressure monitoring cap with an integral protruding round hollow stem without flats in the second embodiment.

FIG. 13 is a cross sectional view taken along lines 13-13 of FIG. 14.

FIG. 14 is a left side view of tire pressure monitoring cap illustrating an alternate third embodiment of the tire pressure monitoring cap having a dome shape with wrench flats on the dome.

FIG. 15 is a cross sectional view taken along lines 15-15 of FIG. 16.

FIG. 16 is a left side view of illustrating an alternate fourth embodiment of the tire pressure monitoring cap having a dome shape without wrench flats.

FIG. 17 is a partial isometric view of a typical tire pressure inflation valve having a straight stem.

FIG. 18 is a cross sectional view taken along lines 18-18 of FIG. 17.

FIG. 19 is a front view of a typical tire pressure inflation valve stem having an angled distal end flange.

FIG. 20 is a front view of a typical tire pressure inflation valve stem having a curved distal end flange.

FIG. 21 is a front view of a typical tire pressure inflation valve stem having a hook shape distal end flange

FIG. 22 is a partial isometric view of a typical tire pressure inflation valve assembly utilizing a rim spud having a distal end flange, utilized in conjunction with a bent swivel valve.

FIG. 23 is a fragmentary isometric view of a typical tire pressure inflation valve stem with a round distal end flange.

FIG. 24 is a fragmentary isometric view of a typical tire pressure inflation valve stem with a hexagonal shaped distal end flange.

FIG. 25 is a fragmentary isometric view of a typical tire pressure inflation valve stem with a polygonal shaped distal end flange.

FIG. 26 is a partial isometric view of the valve with the adapter assembly in the second embodiment, with the tire pressure monitor shown in dashed lines as it is not part of the invention.

FIG. 27 is a top elevation view of the valve with the adapter assembly in the second embodiment, with the tire pressure monitor shown in dashed lines as it is not part of the invention.

FIG. 28 is a partial cross sectional view taken along lines 28-28 of FIG. 27.

FIG. 29 is an exploded partial isometric view of the valve and the adapter assembly in the second embodiment.

FIG. 30 is a top plan view of the aftermarket 540 series grommet.

FIG. 31 is a side view of the aftermarket 540 series grommet.

FIG. 32 is a cross sectional view taken along lines 32-32 of FIG. 31.

FIG. 33 is a partial isometric view of the valve with the adapter assembly in the third embodiment, with the tire pressure monitor shown in dashed lines as it is not part of the invention.

FIG. 34 is a top elevation view of the valve with the adapter assembly in the third embodiment, with the tire pressure monitor shown in dashed lines as it is not part of the invention.

FIG. 35 is a partial cross sectional view taken along lines 35-35 of FIG. 34.

FIG. 36 is an exploded partial isometric view of the valve and the adapter assembly in the third embodiment.

FIG. 37 is a top plan view of the aftermarket 550 series grommet.

FIG. 38 is a side view of the aftermarket 550 series grommet.

FIG. 39 is a cross sectional view taken along lines 39-39 of FIG. 38.

### BEST MODE FOR CARRYING OUT THE INVENTION

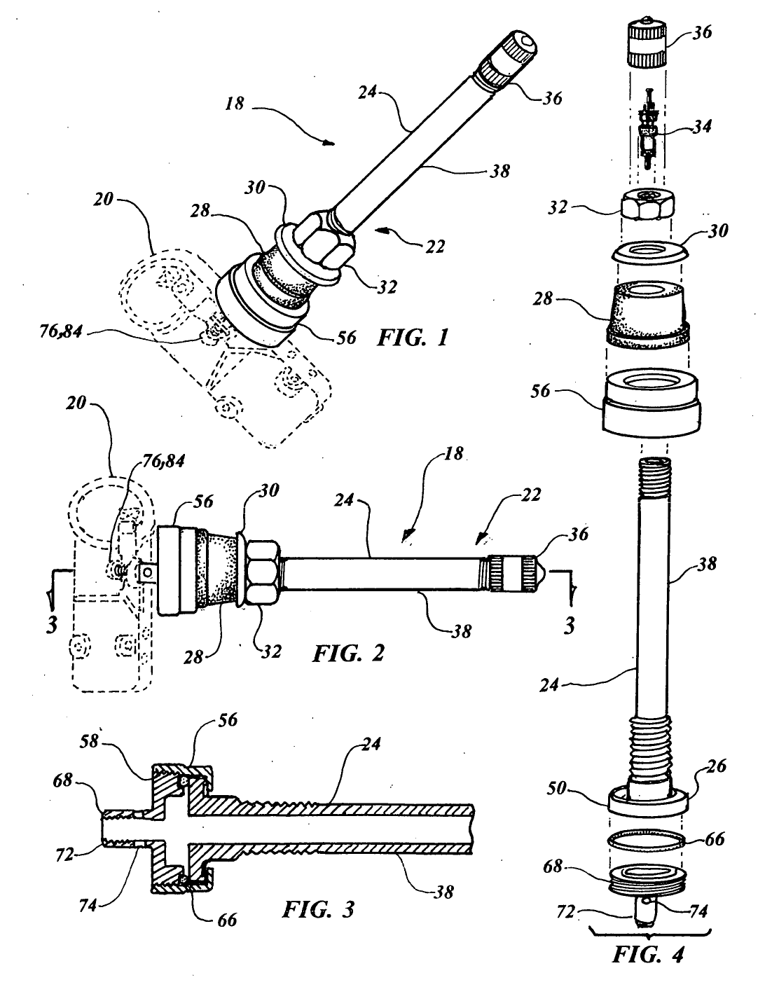

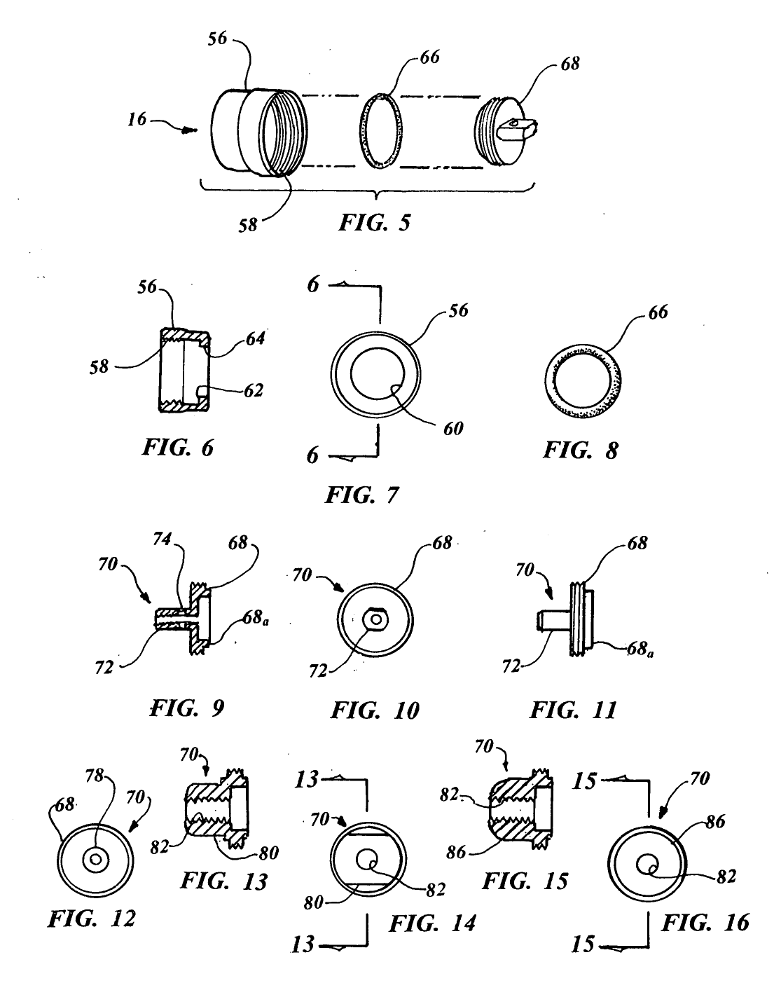

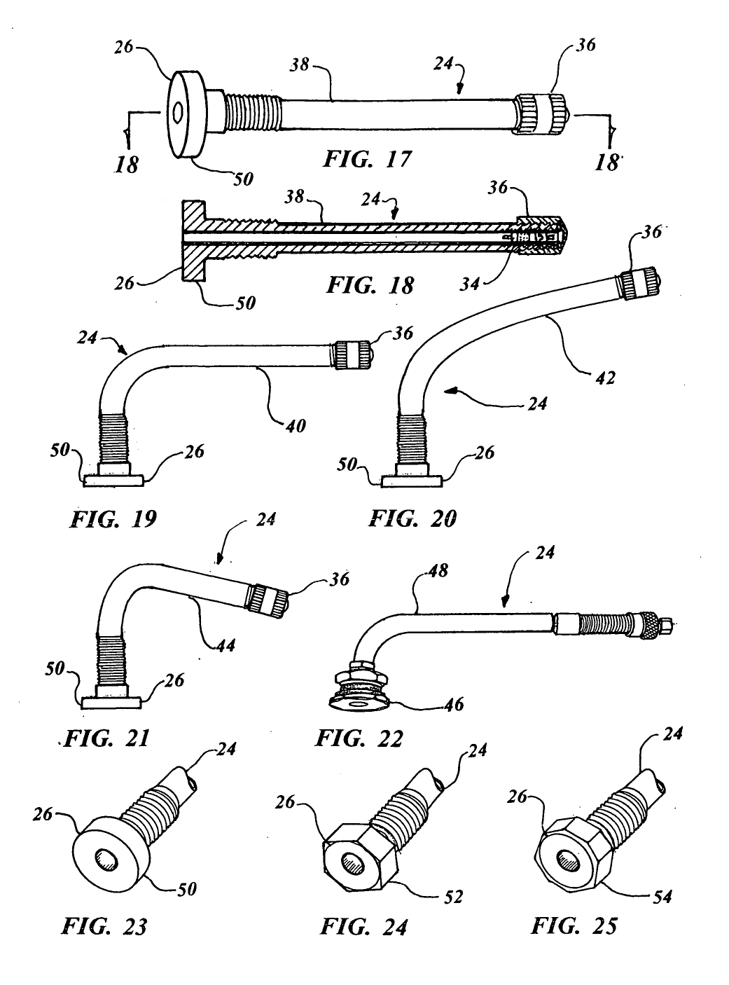

The best mode for carrying out the invention is presented in terms of a preferred second and third embodiment. The preferred embodiment is for use with the industry standard 500 series tire inflation valve shown in FIGS. 1 through 11. This embodiment is comprised of an adapter 16, shown in FIGS. 5 through 11 for incorporating a tire pressure monitor 20 onto a tire inflation valve 22, illustrated in FIGS. 17 through 25.

The tire pressure inflation valve 22 in conjunction with the adapter 16 completes an adapter assembly, 18 depicted in FIGS. 1 through 4. The tire pressure inflation valve 22 is of the type in common use with aluminum or steel wheels consisting of a hollow metallic valve stem 24 with a distal end flange 26, a resilient grommet 28, a dished washer 30, a hex nut 32, an air valve core 34 and a valve cap 36 attached to the proximal end of the valve stem 24, as illustrated exploded in FIG. 4.

The tire pressure inflation valve stem 24 may have any of a variety of configurations, but not limited to, a straight stem 38, as illustrated in FIGS. 17 and 18, an angled stem 40, as shown in FIG. 19, a curved stem 42, as depicted in FIG. 20 and a hook shaped stem 44, shown in FIG. 21. The stems 38-44 may preferably have a length from 2.00 inch (5.08 cm) to 9.25 inches (23.50 cm) long and a hollow bore with an inside diameter of from 0.19 inch (0.48 cm) to 0.44 inch (1.12 cm), however other lengths, configurations and sizes still fall into the scope of this invention.

It is even possible to utilize a rim spud 46 and a single bend swivel valve 48 for the larger size 13/16 inch rim hole in industrial applications, as illustrated in FIG. 22.

The tire pressure inflation valve distal end flange 26 configuration has preferably a round flange 50, as illustrated in FIG. 23 or it may be have a hexagonal flange 52, as shown in FIG. 24 or even a polygonal flange 54, depicted in FIG. 25. In the event of the latter configurations a resilient seal is simply sized to fit onto a completely unobstructed area of the flange 52 or 54.

The adapter 16 utilizes a hollow adapter collar 56 shown in FIGS. 5 through 7 and has a configuration that partially surrounds and is internally retained by the distal end flange 26, as depicted in the cross section of FIG. 3. This configuration has a cup-like shape with a hole in its bottom, with the collar 56 having an inside diameter of sufficient size to clear the outside edge of the distal end flange 26. The adapter collar 56 includes internal threads 58, also a clearance hole 60 within its bottom forming an inwardly facing lip 62, illustrated best in FIGS. 6 and 7.

The inwardly facing lip 62 is preferably 0.035 inches (0.09 cm) thick, with a lip inside diameter 64 of a size permitting the inflation valve stem 24 to slide unrestricted to within, and the lip 62 interfacing with the distal end flange 26 on a side facing the valve core 34 proximal end.

The adapter collar 56 may be formed of any suitable material such as reinforced thermoplastic, steel, aluminum etc. however it is preferable to be formed of brass.

A resilient O-ring 66 is positioned on an exposed surface of the distal end flange 26 contiguously engaging both the flange 26 and an inside surface of the adapter collar 56, as shown in the cross section of FIG. 3. It is preferred that the O-ring 66 have a nominal diameter of ¾ inch (1.91 cm) for conventional valve stems that include a distal end flange 26, however the size may vary for other configured valve stems. The use of the O-ring 66 creates a secondary sealing function in the event the grommet 28 on the valve 22 permits a leak path from ambient to the pressurized area of the tire.

The material of the O-ring 66 may be any type that is applicable to the application such as neoprene, styrene butadiene (SBR), ethylene propylene, polyurethane, butyl rubber or resilient thermoplastic resin.

The final element of the adapter 16 is a tire pressure monitoring cap 68 that incorporates integral external monitor mounting means 70, which could include any number of different embodiments compatible with conventional tire pressure monitors 20, still being within the scope of the invention.

The cap 68, illustrated in FIGS. 9 through 16, is threadably attached to the adapter collar 56 and is disposed above and compresses the O-ring 66 between the cap 68, collar 56 and end flange 26, as shown in the cross section of FIG. 3. The cap 68 permits the tire pressure monitor 20 to be attached onto the cap 68, providing the inflation valve 22 to be modified for use with a tire pressure monitoring system (TPMS).

The tire pressure monitoring cap 68, in the preferred embodiment, is shown in FIGS. 9 through 11 and is preferably formed of brass having threads on an outside diameter for mating with threads in the adapter collar 56. The cap 68 incorporates a raised rim 68ₐ on an inside surface having a diameter and thickness compatible with said O-ring 66 as illustrated in FIGS. 3 and 6.

The preferred embodiment of the external monitor mounting means 70, depicted in FIGS. 9 through 11, consists of an integral protruding round hollow stem 72 with flats on opposed sides, also having a lateral air egress hole 74 there through and screw threads within the hollow of the stem 72 on a distal end, for mounting the monitor 20 (sensor/transmitter) with a threaded fastener 76, supplied with the monitor 20.

Another variation of the external monitor mounting means 70, has the same configuration as illustrated in FIGS. 9 through 11, except the flats are omitted leaving the stem 78 completely round and hollow, as depicted in FIG. 12.

Yet another variation of the external monitor mounting means 70, shown in FIGS. 13 and 14, consists of a hollow radial dome with wrench flats on opposed sides 80 and centrally positioned screw threads 80 within the dome hollow. The threads 80 are for mounting the monitor 20 (sensor/transmitter) with a hollow threaded fastener 84, supplied with the monitor 20, which is used within the tire to detect and transmit tire pressure.

Still another variation of the external monitor mounting means 70, shown in FIGS. 15 and 16, consists of a of the same hollow radial dome as above, however without wrench flats 86 on opposed sides. In both embodiments the hollow radial dome 80 and 86 have a radius of at least 0.14 inches (0.36 cm).

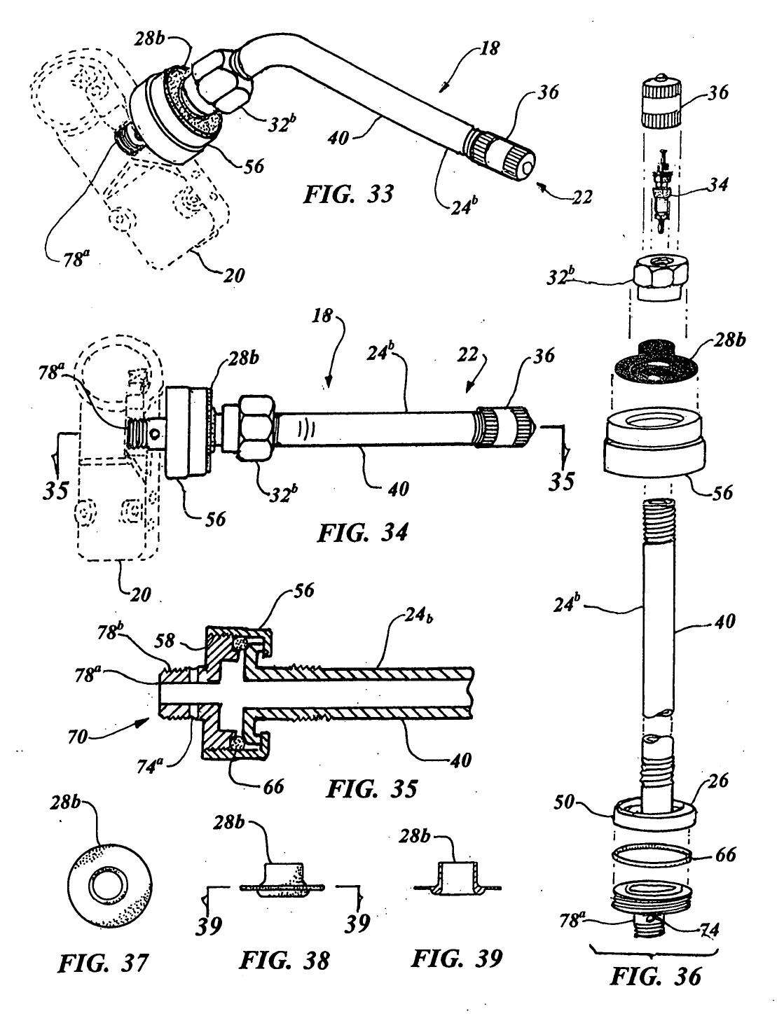

A fifth variation of the external monitor mounting means 70, is illustrated in the FIGS. 33 through 36 of the third embodiment, consisting of a hollow round threaded stem 78^{a} having external threads 78^{b} on the distal end. The threaded stem 78^{a} is much like the threads on the valve stem 24, 24^{a} and 24^{b} for retaining the valve cap 36 and is adjacent to the lateral egress hole 74^{a} as depicted in FIGS. 33 through 36. The tire pressure monitor 20 contains mating female threads for physical attachment to the tire pressure monitoring cap 68 without requiring a threaded fastener of any kind.

In use the adapter 16 is packaged in a kit that would include the adapter collar 56, the O-ring 66 and the cap 68 along with appropriate instructions. Where practical the tire inflation valve 22 could alternatively be combined in place with the adapter 16 forming a complete adapter assembly 18 ready for a tire pressure monitor 20 to be installed, or even having the tire pressure monitor 20 included, if desired.

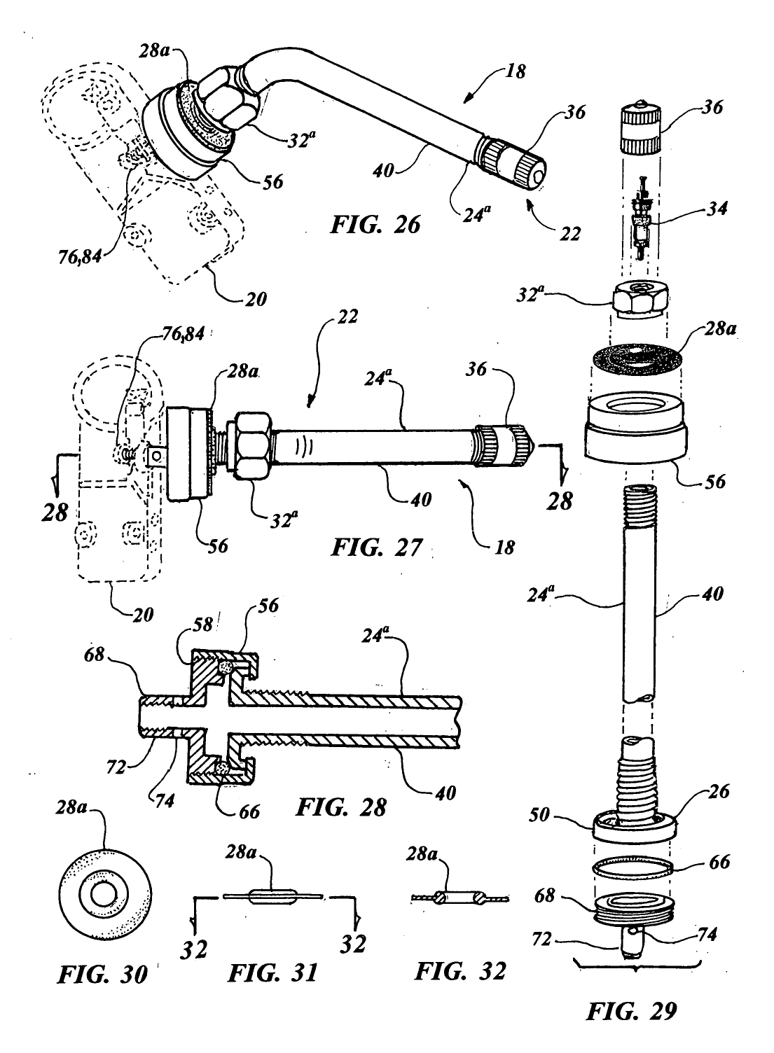

The second embodiment of the invention is illustrated in FIGS. 26 through 32 along with FIGS. 5 through 21. This second embodiment is the same as the preferred embodiment except it utilizes a 540 series tire inflation valve instead of the 500 series therefore the element descriptions used in common retain the same numerical designations in the drawings.

There are three exceptions of the designations taken for the 540 series tire inflation valve wherein the stem 24, is now designated 24^{a} as it still retains the same basic shape with the only difference is in that the distal end flange is slightly smaller in diameter which has no effect on its function or interface. FIGS. 26 through 29 illustrate the angled stem variation which is the same as shown in FIG. 19.

The second exception diverges from the preferred embodiment as the resilient grommet 28 has a different configuration and replaces the original equipment manufacturer grommet with an aftermarket 540 series grommet 28^{a}. This replacement grommet 28^{a} has a configuration duplicating the commercial 540 series grommet plus it adds an integral outwardly extending disc portion centrally positioned on an imaginary centerline. The disc portion has an outside diameter essentially the same outside diameter as the adapter collar 56 with a thickness of at least 0.020 inches, and is illustrated in FIGS. 30 through 32. The advantage of this aftermarket grommet 28^{a} is that it adds integrity to the seal between the valve and the wheel rim along with preventing electrolysis caused by dissimilar metals in contact with each other which in time could encourage air leakage from the tire.

The third deviation from the preferred embodiment is the use of the dished washer 30 and hex nut 32 which are replaced by a single hex nut 32^{a} having a diametrical flat surface for contacting the grommet 28^{a}, shown in best in FIG. 29.

Since the components remaining in the adapter assembly in this second embodiment are identical, its functionality is duplicated entirely.

The third embodiment of the invention is illustrated in FIGS. 33 through 39 along with FIGS. 5 through 21. This third embodiment is the same as the preferred embodiment except it utilizes a 550 series tire inflation valve instead of the 500 series therefore the element descriptions used in common retain the same numerical designations in the drawings.

There are three exceptions taken for the 550 series tire inflation valve wherein the stem, which is now designated 24^{b} retains all of the same variations in shape but the only difference is the distal end flange is slightly smaller in diameter which however has no effect on its function or interface. FIGS. 33 through 36 illustrate the angled stem variation.

The second divergence embodiment from the preferred embodiment is in the resilient grommet 28 which has an entirely different configuration and completely replaces the original equipment manufacturer grommet with an aftermarket 550 series grommet 28^{b}. This replacement grommet 28^{b} has a configuration duplicating the commercial 550 series grommet in addition adds an integral outwardly extending disc portion, much like a photograph of the Saturn rings. The disc portion has an outside diameter essentially the same outside diameter as the adapter collar 56 with a thickness of at least 0.020 inches, as illustrated in FIGS. 37 through 39. The advantage of this aftermarket grommet 28^{b} is that it adds integrity to the seal between the valve and the wheel rim along with preventing electrolysis caused by dissimilar metals in contact with each other which in time could encourage air leakage from the tire.

The third deviation embodiment from the preferred embodiment is the use of the dished washer 30 and hex nut 32 which are replaced by a single hex nut 32^{b} having an internal cone face for contacting the grommet 28^{b}, shown in best in the cross section of FIG. 35.

The components remaining in the adapter assembly of this third embodiment are identical, therefore functionality is duplicated completely.

While the invention has been described in complete detail and pictorially shown in the accompanying drawings, it is not to be limited to such details, since many changes and modifications may be made to the invention without departing from the spirit and scope thereof. Hence, it is described to cover any and all modifications and forms which may come within the language and scope of the appended claims.

1. An adapter assembly for incorporating a tire pressure monitor onto truck tire pressure inflation valves which comprises:
a tire pressure inflation valve assembly having a distal end flange,
an adapter collar extending over the end flange, and
a monitoring cap disposed inside the collar, said cap including external mounting means for attaching the tire pressure monitor.

2. An adapter assembly for incorporating a tire pressure monitor onto truck tire pressure inflation valves which comprises:
a) a tire pressure inflation valve assembly having a distal end flange,
b) an adapter collar having a configuration sized to fit over said end flange, and
c) a tire pressure monitoring cap, having external monitor mounting means, said cap threadably attached to said adapter collar contiguously embracing the end flange, with the cap providing an interface with said tire pressure monitor for attachment to the adapter assembly, permitting the inflation valve to be modified for use with a tire pressure monitoring system (TPMS).

3. An adapter assembly for incorporating a tire pressure monitor onto truck tire pressure inflation valves which comprises:
a) a tire pressure inflation valve assembly, with the valve assembly having a distal end flange,
b) a hollow adapter collar having a configuration sized to fit over and be internally retained by said distal end flange,
c) an O-ring positioned on said end flange engaging said adapter collar inside surface, and
d) a tire pressure monitoring cap, having external monitor mounting means, said cap threadably attached to said adapter collar contiguously embracing the end flange, with the cap providing an interface with said tire pressure monitor for attachment to the adapter assembly, permitting the inflation valve to be modified for use with a tire pressure monitoring system (TPMS) also preventing possible minor leaks.

4. The adapter assembly as recited in claim 3 wherein said tire pressure inflation valve further comprises a type for use with aluminum or steel wheels.

5. The adapter assembly as recited in claim 3 wherein said tire pressure inflation valve further having a hollow metallic flanged stem, a commercial 500 series grommet, a dished washer, a hex nut, an air valve core and a valve cap attached thereunto.

6. The adapter assembly as recited in claim 3 wherein said tire pressure inflation valve further having a hollow metallic flanged stem, a aftermarket 540 series grommet, a hex nut, an air valve core and a valve cap attached thereunto.

7. The adapter assembly as recited in claim 6 wherein said aftermarket 540 series grommet further comprises a configuration duplicating a commercial 540 series grommet along with an integral outwardly extending disc portion centrally positioned on a imaginary centerline, the outside diameter essentially the same as the adapter collar and a thickness of at least 0.020 inches.

8. The adapter assembly as recited in claim 3 wherein said tire pressure inflation valve further having a hollow metallic flanged stem, a aftermarket 550 series grommet, an internal cone faced hex nut, an air valve core and a valve cap attached thereunto.

9. The adapter assembly as recited in claim 8 wherein said aftermarket 550 series grommet further comprises a configuration duplicating a commercial 550 series grommet further having an integral outwardly extending disc portion centrally positioned on an imaginary centerline of a neck flange, essentially the outside diameter the same as the adapter collar and a thickness of at least 0.020 inches.

10. The adapter assembly as recited in claim 3 wherein said tire pressure inflation valve further comprises a rim spud type for use with single bend swivel valves.

11. The adapter assembly as recited in claim 3 wherein said adapter collar further comprises a cap-like configuration with an inside diameter sufficient to clear the outside of distal end flange, wherein said adapter collar having internal threads and a clearance hole within an end forming an inwardly facing lip, wherein the lip inside diameter of a size permitting the inflation valve stem to slide unrestricted within and the lip interfacing with the distal end flange on a side facing a valve core proximal end.

12. The adapter assembly as recited in claim 3 wherein said O-ring configured with an outside diameter sufficient to engage the adapter collar inside diameter and a thickness sufficient to interface with the distal end flange.

13. The adapter assembly as recited in claim 3 wherein said O-ring further is comprised of a material selected from the group consisting of neoprene, styrene butadiene (SBR), ethylene propylene, polyurethane, butyl rubber, Viton® and thermoplastic.

14. The adapter assembly as recited in claim 3 wherein said tire pressure monitoring cap having threads on an outside diameter for mating with the adapter collar and at least a 0.14 inch (0.36 cm) bore within the monitor mounting means.

15. The adapter assembly as recited in claim 3 wherein said tire pressure monitoring cap further comprises a raised rim on an inside surface having a diameter and thickness compatible with said O-ring.

16. The adapter assembly as recited in claim 3 wherein said monitor mounting means of said monitoring cap further comprises an integral round hollow stem flattened on opposed sides having a lateral air egress hole therethough and screw threads within the hollow of the stem on a distal end for mounting a monitor (sensor/transmitter) with a threaded fastener, to detect tire pressure.

17. The adapter assembly as recited in claim 3 wherein said monitor mounting means of said monitoring cap further comprises an integral round hollow stem having a lateral air egress hole therethough and screw threads within the hollow of the stem on a distal end for mounting a monitor (sensor/transmitter) with a threaded fastener, to detect tire pressure.

18. The adapter assembly as recited in claim 3 wherein said monitor mounting means of said monitoring cap further comprises a hollow radial dome having centrally positioned screw threads within the dome hollow, for mounting a monitor (sensor/transmitter) with a hollow threaded fastener, to detect tire pressure, wherein said hollow radial dome has a radius of at least 0.14 inches (0.36 cm).

19. The adapter assembly as recited in claim 3 wherein said monitor mounting means of said monitoring cap further comprises a hollow radial dome with wrench flats on opposed sides having centrally positioned screw threads within the dome hollow, wherein said hollow radial dome has a radius of at least 0.14 inches (0.36 cm).

20. The adapter assembly as recited in claim 3 wherein said monitor mounting means of said monitoring cap further comprises a hollow round threaded stem having external threads on the distal end, with the threads adjacent to a lateral air egress hole therethough for mounting a monitor (sensor/transmitter) having a mating threaded hole therein.
